(19) United States
(12) Patent Application Publication
(10) Pub. No.: US 2022/0119652 A1
(43) Pub. Date: Apr. 21, 2022

(54) DECORATIVE SHEET AND MANUFACTURING METHOD THEREFOR

(71) Applicant: UCHIYAMA MANUFACTURING CORP., Okayama-shi (JP)

(72) Inventors: Mari KAWATA, Akaiwa-shi (JP); Tomohisa YAMAMOTO, Akaiwa-shi (JP); Kazuhiro SHIMIZU, Aki-gun (JP); Yuki NISHIYAMA, Aki-gun (JP)

(73) Assignee: UCHIYAMA MANUFACTURING CORP., Okayama-shi (JP)

(21) Appl. No.: 17/502,865

(22) Filed: Oct. 15, 2021

(30) Foreign Application Priority Data
Oct. 16, 2020 (JP) 2020-174607

(51) Int. Cl. C09D 5/32; C09D 175/04; C09D 7/61; B44C 5/04

(52) U.S. Cl. CPC C09D 5/32; B44C 5/04; C09D 7/61; C09D 175/04

(57) ABSTRACT

There is provided a decorative sheet composed of a multilayer structure having an intermediate layer and a protective layer on a surface of a cork sheet, wherein a decolorized cork layer is formed on the surface of the cork sheet in contact with the intermediate layer; the intermediate layer is a coated film formed by drying an aqueous emulsion; the protective layer comprises an ultraviolet absorbing layer made of a resin composition containing an ultraviolet absorbing agent; and the surface of the protective layer is a design surface. Such a decorative sheet has excellent light resistance and fastness to rubbing, and also maintains an appearance peculiar to cork.

### TECHNICAL FIELD

The present invention relates to a decorative sheet composed of a multilayer structure having an intermediate layer and a protective layer on a surface of a cork sheet, and a manufacturing method therefor.

### BACKGROUND ART

Cork sheets have a unique texture and are excellent in design, elastic and excellent in tactile sensation, and therefore, have been widely used as decorative sheets and the like.

However, since cork is easily discolored by light, its application and place of use may be restricted. In addition, since cork has a relatively low fastness to rubbing, its appearance may be deteriorated by discoloration due to contact with an object or contamination. A known method for improving light resistance and fastness to rubbing of cork is a method comprising painting the surface of a cork sheet. However, when a painted layer is formed on the cork sheet by a known method, sometimes light resistance and fastness to rubbing are still insufficient, and appearance and tactile sensation peculiar to cork are lost. Further, when the paint contains a volatile organic compound, there is a problem in terms of the environment.

Patent Reference No. 1 describes a cork plate having a discoloration preventive layer formed by applying a paint containing a light absorber, a pigment and phenylenediamine to the surface of the cork plate. It is described that for the cork plate, discoloration can be prevented by light absorbing effect of the light absorber and light blocking effect of the pigment and phenylenediamine. However, the cork plate has insufficient fastness to rubbing and still insufficient light resistance.

Patent Reference No. 2 describes a method for producing a natural cork film, comprising forming a laminate of a cork layer and a fiber layer, then decoloring the cork layer for preventing discoloration, and then applying a resin sheet on the fiber layer. Patent Reference No. 2 further describes that a coating layer can be formed on the cork layer by adhering a color resin or a transparent resin via an adhesive or thermocompression bonding, or by applying a color paint or a transparent paint. However, the natural cork film has insufficient light resistance and sometimes has insufficient fastness to rubbing.

### PRIOR ART REFERENCES

### Patent References

Patent Reference No. 1: JP 60-31915 A
Patent Reference No. 2: JP 2018-62167 A

### SUMMARY OF THE INVENTION

### Problems to be Solved by the Invention

To solve the above problems, an objective of the present invention is to provide a decorative sheet having improved light resistance and fastness to rubbing while maintaining an appearance peculiar to cork, as well as a method for manufacturing a decorative sheet, which has a small environmental load.

### Means for Solving the Problems

The above problems can be solved by providing a decorative sheet composed of a multilayer structure having an intermediate layer and a protective layer on a surface of a cork sheet, wherein a decolorized cork layer is formed on the surface of the cork sheet in contact with the intermediate layer; the intermediate layer is a coated film formed by drying an aqueous emulsion; the protective layer comprises an ultraviolet absorbing layer made of a resin composition containing an ultraviolet absorbing agent; and the surface of the protective layer is a design surface.

Here, it is preferable that the ultraviolet absorbing agent is a benzophenone compound containing a hydroxy group.

It is also preferable that the ultraviolet absorbing layer is a coated film formed by drying an aqueous urethane emulsion comprising the ultraviolet absorbing agent. It is also preferable that the resin composition in the ultraviolet absorbing layer comprises 100 parts by mass of a resin and 5 to 60 parts by mass of the ultraviolet absorbing agent. It is also preferable that the protective layer further comprises a layer made of a resin composition free from an ultraviolet absorbing agent; and the layer made of the resin composition free from an ultraviolet absorbing agent is disposed outside the ultraviolet absorbing layer. It is also preferable that a basis weight (g/m²) of the protective layer is larger than a basis weight (g/m²) of the intermediate layer. It is also preferable that the intermediate layer is a coated film formed by drying an aqueous emulsion containing a colorant.

The above problems can be also solved by providing a method for manufacturing a decorative sheet composed of a multilayer structure having an intermediate layer and a protective layer on a surface of a cork sheet, comprising decolorizing the surface of the cork sheet to form a decolorized cork layer; applying an aqueous emulsion on the decolorized cork layer and then drying the emulsion, to form the intermediate layer; and applying an aqueous emulsion containing an ultraviolet absorbing agent on the intermediate layer and then drying the emulsion, to form the protective layer.

### Effects of the Invention

The decorative sheet of the present invention has excellent light resistance and fastness to rubbing, and also maintains an appearance peculiar to cork. According to the manufacturing method of the present invention, such a decorative sheet can be manufactured while suppressing an environmental load.

### BRIEF DESCRIPTION OF THE DRAWINGS

FIG. 1 is a schematic view showing an example of a decorative sheet of the present invention.

### MODES FOR CARRYING OUT THE INVENTION

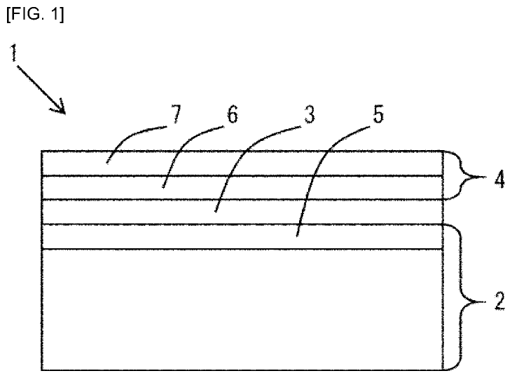

FIG. 1 is a schematic view showing an example of a decorative sheet of the present invention. The decorative sheet 1 of the present invention is a decorative sheet composed of a multilayer structure having an intermediate layer 3 and a protective layer 4 on a surface of a cork sheet 2, wherein a decolorized cork layer 5 is formed on the surface of the cork sheet 2 in contact with the intermediate layer 3; the intermediate layer 3 is a coated film formed by drying an aqueous emulsion; the protective layer 4 comprises an ultraviolet absorbing layer 6 made of a resin composition containing an ultraviolet absorbing agent; and the surface of the protective layer 4 is a design surface. The decorative sheet 1 is excellent in light resistance and fastness to rubbing, and also maintains an appearance peculiar to cork. As will be described later, the protective layer 4 can further comprise a layer 7 made of a resin composition free from an ultraviolet absorbing agent, and the layer 7 made of the resin composition free from an ultraviolet absorbing agent can be disposed outside the ultraviolet absorbing layer 6.

There are no particular restrictions to a cork sheet used for the decorative sheet of the present invention; for example, those obtained by slicing a molded product obtained by compression molding a mixture of cork particles and an adhesive.

A thickness of the cork sheet is preferably 1 to 10 mm. If the thickness is less than 1 mm, mechanical strength of the decorative sheet may be insufficient. Meanwhile, if the thickness is more than 10 mm, work efficiency such as decolorization and coating may be lowered.

The decorative sheet of the present invention is composed of a multilayer structure having an intermediate layer and a protective layer on the surface of the cork sheet, and the surface of the protective layer is a design surface. The design surface may be formed on a visible portion when the decorative sheet is used as an interior material for automobiles as described later. Therefore, the intermediate layer and the protective layer can be formed on a part of the surface of the cork sheet. In the light of productivity, it is preferable that the intermediate layer and the protective layer are formed on the entire surface of the cork sheet. Furthermore, the intermediate layer and the protective layer can be formed on only one side of the cork sheet or on both sides.

It is necessary that a decolorized cork layer is formed on the surface of the cork sheet in contact with the intermediate layer. This improves light resistance of the decorative sheet. The decolorized cork layer is formed by decolorizing the surface of the cork sheet. Here, only the vicinity of the surface of the cork sheet can be decolorized, or the inside can be also decolorized. However, herein, the surface of the decolorized cork layer must be visually recognized as whiter and have a higher degree of whiteness than the surface of the cork sheet before decolorization.

The decorative sheet of the present invention has an intermediate layer on the surface of the cork sheet on which the decolorized cork layer is formed, and the decolorized cork layer is in contact with the intermediate layer. The intermediate layer is a coated film formed by drying an aqueous emulsion. By using such an aqueous emulsion, an environmental load is reduced and an original appearance of cork is maintained. The intermediate layer can be formed on a part of the surface of the cork sheet on which the decolorized cork layer is formed, or can be formed on the entire surface, and the latter is preferable.

The intermediate layer contains a resin. Examples of the resin include urethane resins, acrylic resins, alkyd resins, polyester resins, blocked isocyanates, fluororesins, epoxy resins, epoxy acrylate resins, phenol resins, melamine resins, vinylic resins, polyamide resins and cellulose-based resins. Among these, urethane resins and acrylic resins are preferable, and urethanes resin are more preferable.

It is preferable that the intermediate layer further contains a colorant. Examples of the colorant include pigments such as inorganic pigments and organic pigments; dyes such as inorganic dyes and organic dyes; and combinations thereof. A content of the colorant in the intermediate layer can be appropriately adjusted so that the design surface has a desired color depending on the type of the colorant and the like, and it is usually 0.1 to 50 parts by mass based on 100 parts by mass of the resin. A main component of the resin contained in the intermediate layer is preferably a urethane resin or an acrylic resin, more preferably a urethane resin.

Herein, a content of the ultraviolet absorbing agent in the intermediate layer is preferably 0.1 part by mass or less based on 100 parts by mass of the resin, and it is more preferable that the intermediate layer is substantially free from the ultraviolet absorbing agent.

As long as the effects of the present invention are not impaired, the intermediate layer can contain additives other than the resin, the colorant and the ultraviolet absorbing agent. A content of the other additives in the intermediate layer is preferably 20% by mass or less, more preferably 10% by mass or less, still more preferably 5% by mass or less.

A basis weight of the intermediate layer is preferably 5 to 100 g/m². If the basis weight is less than 5 g/m², an appearance of the obtained decorative sheet may be deteriorated. Meanwhile, if the basis weight is more than 100 g/m², a cost may increase.

A thickness of the intermediate layer is preferably 0.05 to 25 μm. If the thickness is less than 0.05 μm, an appearance of the obtained decorative sheet may be deteriorated. The thickness is more preferably 5 μm or more. Meanwhile, if the thickness is more than 25 μm, a cost may increase. The thickness is more preferably 5 μm or less.

The decorative sheet of the present invention has a protective layer on the surface of the intermediate layer. The protective layer comprises an ultraviolet absorbing layer made of a resin composition containing an ultraviolet absorbing agent. By forming the ultraviolet absorbing layer on the surface of the intermediate layer as described above, light resistance and fastness to rubbing of the decorative sheet of the present invention are improved. In particular, forming the ultraviolet absorbing layer together with the decolorized cork layer significantly improves light resistance. The protective layer can be formed on a part of the surface of the intermediate layer or can be formed on the entire surface, and the latter is preferable. The surface of the protective layer is a design surface.

The ultraviolet absorbing layer is made of a resin composition containing an ultraviolet absorbing agent. In the light of a cost, it is preferable that the protective layer includes only the ultraviolet absorbing layer. Examples of the resin contained in the resin composition include urethane resins, acrylic resins, alkyd resins, polyester resins, blocked isocyanates, fluororesins, epoxy resins, epoxy acrylate resins, phenolic resins, melamine resins, vinyl resins, polyamide resins and cellulose-based resins, and urethane resins are particularly preferable. Preferably, a main component of the resin contained in the resin composition is a urethane resin or an acrylic resin, more preferably a urethane resin.

Examples of the ultraviolet absorbing agent contained in the resin composition include benzophenone compounds such as benzophenone, 2,4-dihydroxybenzophenone, 2,2′-dihydroxy-4,4′-dimethoxybenzophenone, 2,2′,4,4′-tetrahydroxybenzophenone, 2-hydroxy-4-n-octyloxybenzophenone, 2-hydroxy-4-methoxybenzophenone and poly(4-(2-acryloyloxyethoxy)-2-hydroxybenzophenone; benzotriazole compounds such as 2-(2H-benzotriazole-2-yl)-4,6-bis(1-methyl-1-phenylethyl)phenol, 2-(2-hydroxy-5-methylphenyl)benzotriazole, and 2-(2-hydroxy-3,5-di-tert-amylphenyl)benzotriazole; cyanoacrylate compounds such as 2,2-bis[{2-cyano-(3,3-diphenylacryloyl)oxy}methyl]propane-1,3-diylbis(2-cyano-3,3-diphenylacrylate), and 2-ethylhexyl 2-cyano-3,3-diphenylacrylate; and salicylate compounds such as phenylsalicylate. Among others, a benzophenone compound is preferable, and a benzophenone compound containing a hydroxy group is more preferable.

The resin composition preferably contains 100 parts by mass of the resin in total and 2 to 60 parts by mass of the ultraviolet absorbing agent. If the content of the ultraviolet absorbing agent is less than 2 parts by mass, light resistance of a obtained decorative sheet may decrease. The content of the ultraviolet absorbing agent is more preferably 5 parts by mass or more, further preferably 15 parts by mass or more, particularly preferably 22 parts by mass or more, most preferably 25 parts by mass or more. Meanwhile, if the content is more than 60 parts by mass, fastness to rubbing of the obtained decorative sheet may decrease. The content is more preferably 50 parts by mass or less, further preferably 40 parts by mass or less, particularly preferably 35 parts by mass or less.

A content of the colorant in the resin composition is preferably 1 part by mass or less based on 100 parts by mass of the resin in total, and it is more preferable that the resin composition is substantially free from the colorant.

The resin composition can contain additives other than the resin, the ultraviolet absorbing agent and the colorant. A content of the other additives in the resin composition is preferably 20% by mass or less, more preferably 10% by mass or less, still more preferably 5% by mass or less.

It is preferable that the ultraviolet absorbing layer is formed by drying an aqueous emulsion containing the ultraviolet absorbing agent. Examples of the resin contained in the aqueous emulsion include those described above as the resin contained in the ultraviolet absorbing layer. The aqueous emulsion is preferably an aqueous urethane emulsion or an aqueous acrylic emulsion, and the former is more preferable.

The protective layer can further comprise a layer made of a resin composition free from an ultraviolet absorbing agent and the layer made of a resin composition free from an ultraviolet absorbing agent can be disposed outside the ultraviolet absorbing layer. As a result, fastness to rubbing of the decorative sheet is further improved. The resin composition free from an ultraviolet absorbing agent is the resin composition used for the ultraviolet absorbing layer as described above, except that it is free from the ultraviolet absorbing agent. When the protective layer comprises a layer other than the ultraviolet absorbing layer, a ratio of a thickness (μm) of the ultraviolet absorbing layer to a total thickness (μm) of the protective layer (ultraviolet absorbing layer/protective layer) is generally 1/9 to 9/1. A ratio of a basis weight (g/m²) of the ultraviolet absorbing layer to a total basis weight (g/m²) of all the layers contained in the protective layer (ultraviolet absorbing layer/protective layer) is generally 1/9 to 9/1.

A thickness of the protective layer is preferably 0.1 to 50 μm. If the thickness is less than 0.1 μm, fastness to rubbing of the decorative sheet may decrease. The thickness is more preferably 1 μm or more. Meanwhile, if the thickness is more than 50 μm, a cost may increase. The thickness is preferably 10 μm or less.

In the light of further improving fastness to rubbing of the decorative sheet, it is preferable that the protective layer is thicker than the intermediate layer. A ratio of a thickness (μm) of the protective layer to a thickness (μm) of the intermediate layer (protective layer/intermediate layer) is more preferably 1.2 or more. Meanwhile, the ratio (protective layer/intermediate layer) is generally 4 or less.

A basis weight of the protective layer is preferably 10 to 300 g/m². If the basis weight is less than 10 g/m², fastness to rubbing of a decorative sheet obtained may decrease. Meanwhile, if the basis weight is more than 300 g/m², a cost may increase.

In the light of further improving fastness to rubbing of the decorative sheet, it is preferable that a basis weight of the protective layer is larger than a basis weight of the intermediate layer. A ratio of a basis weight of the protective layer to a basis weight of the intermediate layer (protective layer/intermediate layer) is more preferably 1.2 or more. Meanwhile, the ratio (protective layer/intermediate layer) is generally 4 or less.

A production method of the present invention is a method for manufacturing a decorative sheet composed of a multilayer structure having an intermediate layer and a protective layer on a surface of a cork sheet, comprising decolorizing the surface of the cork sheet to form a decolorized cork layer; applying an aqueous emulsion on the decolorized cork layer and then drying the emulsion, to form the intermediate layer; and applying an aqueous emulsion containing an ultraviolet absorbing agent on the intermediate layer and then drying the emulsion, to form the protective layer. This method is suitably used as a method for manufacturing the decorative sheet of the present invention described above or the like.

The surface of the cork sheet is decolorized (bleached) to form a decolorized cork layer. A decolorizing liquid used herein can be a known hydrogen peroxide-based decolorizing liquid composed of a mixture containing hydrogen peroxide and water. The mixed solution can further contain ammonia.

There are no particular restrictions to a method for decolorizing the surface of the cork sheet using the decolorizing liquid, including applying the decolorizing liquid to the surface of the cork sheet, impregnating the cork sheet with the decolorizing liquid, and spraying the decolorizing liquid on the surface of the cork sheet. Among these, preferred is applying the decolorizing liquid to the surface of the cork sheet. A specific example of a method for applying the decolorizing liquid to the surface of the cork sheet is applying the decolorizing liquid to the surface of the cork sheet with a brush or a roller.

After decolorizing the surface of the cork sheet to form a decolorized cork layer, an aqueous emulsion is applied on the decolorized cork layer and then dried to form an intermediate layer.

The aqueous emulsion used for forming the intermediate layer is a dispersion of a resin in an aqueous medium. It is preferable that the aqueous emulsion further contains a colorant. The resin and the colorant contained in the aqueous emulsion can be those contained in the intermediate layer of the decorative sheet of the present invention as described above.

From an environmental point of view, a content of water in the aqueous medium is preferably 50% by mass or more. Components other than water are preferably water-soluble organic solvents which is miscible with water in any ratio, more preferably an alcohol and a ketone, further preferably an alcohol.

A solid content in the aqueous emulsion is preferably 1 to 90% by mass. If the solid content is less than 1% by mass, it may be difficult to form a thick coated film or a drying efficiency may be lowered. The solid content is more preferably 5% by mass or more, further preferably 10% by mass or more. Meanwhile, if the solid content is more than 90% by mass, fluidity may be so decreased that applying may be difficult. The solid content is more preferably 75% by mass or less, further preferably 50% by mass or less.

The aqueous emulsion may contain additives other than the resin, the aqueous medium, the colorant and the ultraviolet absorbing agent as long as the effects of the present invention are not impaired. Examples of the other additives include dispersants, anti-settling agents, emulsifiers, thickeners, antifoaming agents, antifungal agents, preservatives, anti-skinning agents and anti-sagging agents. The content of the other additives in the aqueous emulsion is preferably 20% by mass or less, more preferably 10% by mass or less, still more preferably 5% by mass or less.

There are no particular restrictions to a method for applying the aqueous emulsion on the decolorized cork layer; including applying the aqueous emulsion on the decolorized cork layer, impregnating the cork sheet with the aqueous emulsion, and spraying the aqueous emulsion on the decolorized cork layer. Among these, preferred is applying the aqueous emulsion on the decolorized cork layer. Specifically, a method is applying the aqueous emulsion on the decolorized cork layer using a brush or a roller.

After applying the aqueous emulsion on the decolorized cork layer, the aqueous emulsion is dried. There are no particular restrictions to the drying conditions, and generally, a drying temperature is 15° C. to 100° C., and a drying time is 15 minutes to 1 day.

After forming the intermediate layer on the surface of the decolorized cork layer, a protective layer is formed by applying an aqueous emulsion containing an ultraviolet absorbing agent on the intermediate layer followed by drying it.

The aqueous emulsion used to form the protective layer is a dispersion of a resin in an aqueous medium. The resin and the ultraviolet absorbing agent contained in the aqueous emulsion are those contained in the protective layer of the decorative sheet of the present invention as described above.

The aqueous medium is that used for forming the intermediate layer as described above.

A solid content in the aqueous emulsion used for forming the protective layer is preferably 1 to 90% by mass. If the solid content is less than 1% by mass, it may be difficult to form a thick coated film or a drying efficiency may be lowered. The solid content is more preferably 5% by mass or more, further preferably 10% by mass or more. Meanwhile, if the solid content is more than 90% by mass, fluidity may be so decreased that coating may be difficult. The solid content is more preferably 75% by mass or less, further preferably 50%) by mass or less.

As long as the effects of the present invention are not impaired, the aqueous emulsion used for forming the protective layer can contain additives other than the resin, the aqueous medium, the colorant and the ultraviolet absorbing agent. The other additives can be those used for forming the intermediate layer as described above.

There are no particular restrictions to a method for applying the aqueous emulsion on the intermediate layer and a method for drying the applied aqueous emulsion, and the methods can be those used for forming the intermediate layer as described above.

As the protective layer, in addition to the ultraviolet absorbing layer made of a coated film formed by drying the above-mentioned aqueous emulsion containing an ultraviolet absorbing agent, a layer made of a coated film formed by drying an aqueous solution free from the ultraviolet absorbing agent can be formed. The layer can be formed by applying the aqueous emulsion free from the ultraviolet absorbing agent on the ultraviolet absorbing layer followed by drying it.

The decorative sheet of the present invention can be used as a composite molded article formed by integral molding of a decorative sheet and a resin molded article which is bonded to the rear face of the cork sheet. The composite molded article can be used as an interior material for automobiles such as a door trim, an instrument panel, a console, and a cup holder.

The decorative sheet of the present invention thus obtained is excellent in light resistance and fastness to rubbing, and also maintains an appearance peculiar to cork. Therefore, the decorative sheet is suitably used for applications such as interior materials for automobiles and buildings.

### EXAMPLES

There will be further specifically described the present invention with reference to Examples.

### [Light Resistance]

A surface of a protective layer of a decorative sheet was irradiated with ultraviolet rays using a light resistance tester in accordance with JIS B 7751. The ultraviolet irradiation conditions are as shown below.

Light source: Ultraviolet carbon arc light (in accordance with JIS L0842)

Black panel temperature: 63±3° C.

Irradiation time: 200 hours

According to the following criteria, a discoloration degree of the surface of the decorative sheet on the protective layer side after irradiation was evaluated by visually observing the protective layer of the decorative sheet not irradiated with ultraviolet rays and the decorative sheet after irradiation with ultraviolet rays, and the discoloration degree was used as an index of light resistance of the decorative sheet. A discoloration degree was measured by visually comparing a gray scale of 1 to 5 grades with each decorative sheet.

A: Discoloration degree of 20% or less

B: Discoloration degree of more than 20% and 40% or less

C: Discoloration degree of more than 40% and 60% or less

D: Discoloration degree of more than 60% and 80% or less

E: Discoloration degree of more than 80%

### [Fastness to Rubbing]

A rubbing test of the decorative sheet was conducted under the following conditions.

Testing machine: Type II rubbing tester (Gakushin method)

Friction element: White cotton cloth for friction

Load: 5 N

Speed: 30 times/min

Number of reciprocating motions: 5000 times

Change in appearance of the decorative sheet after the rubbing test compared with the decorative sheet before the rubbing test was visually observed, and fastness to rubbing of the decorative sheet was evaluated in accordance with the following criteria.

A: Appearance was unchanged.

B: Appearance was slightly changed.

C: Appearance was significantly changed.

### Example 1

As a cork sheet, a cork molded product obtained by compression-molding a mixture of cork particles and an adhesive was prepared, and the cork molded product was sliced into a cork sheet manufactured by Uchiyama Manufacturing Corp. having a thickness of 2 mm. A hydrogen peroxide-based bleaching solution for wood was applied to the entire surface of one side of the cork sheet, and then left at room temperature for 1 hour for drying. As described above, one side of the cork sheet was decolorized (bleached) to form a decolorized cork layer in one side of the cork sheet. The surface of the decolorized cork layer was visually recognized as whiter with a higher whiteness than the surface of the cork sheet before decolorization.

Next, an aqueous urethane emulsion (“Aqueous VATONFx Natural Brown” manufactured by Otani Paint Co., Ltd.) was applied to the entire surface of the decolorized cork layer of the cork sheet using a roller, and then left at room temperature for 2 hours for drying, to form an intermediate layer made of a coated film with a predetermined thickness on the surface of the decolorized cork layer. The aqueous urethane emulsion was prepared by dispersing or dissolving a resin containing a vegetable oil-based urethane resin as a main component, an inorganic pigment (natural brown) as a colorant, and other additives in an aqueous medium containing water and an alcohol solvent. A composition of the aqueous urethane emulsion is a synthetic resin: 14.0% by mass, water: 65.0 to 68.0% by mass, an alcohol solvent: 14.0% by mass, inorganic substances (coloring pigments, etc.): 0.1 to 3.0% by mass, and other additives: 4.0% by mass. The synthetic resin contained a urethane resin as a main component. A basis weight of the intermediate layer formed on the surface of the cork layer was 60 g/m². It was confirmed by visual observation that the surface of the intermediate layer was colored in a natural brown color, and the surface of the intermediate layer had a lower whiteness than the surface of the decolorized cork layer.

30 parts by mass of an ultraviolet absorbing agent was added to 300 parts by mass of a moisture-curable aqueous urethane coating agent “Aqueous VATONFx Top Clear” manufactured by Otani Paint Co., Ltd., to give an aqueous urethane emulsion containing the ultraviolet absorbing agent. A composition of the aqueous urethane coating agent was a synthetic resin: 35% by mass, water: 56.3% by mass, an alcohol solvent: 7.4% by mass, and other additives: 1.0% by mass. The synthetic resin contained a urethane resin as a main component. The ultraviolet absorbing agent was 2,4-dihydroxybenzophenone, which is a benzophenone compound containing a hydroxyl group. The aqueous urethane emulsion was applied to the entire surface of the intermediate layer using a roller, and then left at room temperature for 1 day for drying, to form an ultraviolet absorbing layer composed of a coated film with a predetermined thickness on the surface of the intermediate layer. The ultraviolet absorbing layer acts as a protective layer which protects the intermediate layer from abrasion. The resin composition in the ultraviolet absorbing layer contains 28.6 parts by mass of the ultraviolet absorbing agent based on 100 parts by mass of the total resin. The ultraviolet absorbing layer had a basis weight of 80 g/m², which was larger than that of the intermediate layer.

### Examples 2 to 5

A decorative sheet was prepared and evaluated as described in Example 1 except that the amount of an ultraviolet absorbing agent added was adjusted as shown in Table 1. The results are shown in Table 1. In each decorative sheet, a basis weight of an intermediate layer was 60 g/m², and a basis weight of an ultraviolet absorbing layer was 80 g/m². A basis weight of each layer was adjusted by varying the application amount.

### Example 6

A decorative sheet was prepared and evaluated as described in Example 1 except that a coating agent used for forming an ultraviolet absorbing layer was an aqueous acrylic coating agent. The acrylic coating agent used was a coating agent “Nikasol” manufactured by Nippon Carbide Industries Co., Inc. The results are shown in Table 1. The acrylic coating agent contains 30 to 40% by mass of a solid containing an acrylic resin as a main component and 60 to 70% by mass of water. In the decorative sheet obtained, a basis weight of an intermediate layer was 60 g/m², and a basis weight of an ultraviolet absorbing layer was 80 g/m². A basis weight of each layer was adjusted by varying the application amount.

### Examples 7 and 8

A decorative sheet was prepared and evaluated as described in Example 1 except that the type of an ultraviolet absorbing agent was changed as shown in Table 1. The results are shown in Table 1. In Example 7, 30 parts by mass of a benzotriazole compound was added to 300 parts by mass of the aqueous urethane coating agent as an ultraviolet absorbing agent. In Example 8, 30 parts by mass of a cyanoacrylate compound as an ultraviolet absorbing agent was added to 300 parts by mass of the aqueous urethane coating agent. In each decorative sheet, a basis weight of an intermediate layer was 60 g/m², and a basis weight of an ultraviolet absorbing layer was 80 g/m². A basis weight of each layer was adjusted by varying the application amount.

### Comparative Example 1

A cork sheet manufactured by Uchiyama Manufacturing Corp. was evaluated as described in Example 1. The results are shown in Table 1.

### Comparative Example 2

A decorative sheet was prepared and evaluated as described in Example 1 except that an intermediate layer or an ultraviolet absorbing layer was not formed. The results are shown in Table 1.

### Comparative Example 3

A decorative sheet was prepared and evaluated as described in Example 1 except that an ultraviolet absorbing layer was not formed. The results are shown in Table 1. A basis weight of an intermediate layer was 60 g/m². A basis weight was adjusted by varying the application amount.

### Comparative Example 4

A decorative sheet was prepared and evaluated as described in Example 1 except that an ultraviolet absorbing agent was not added. The results are shown in Table 1. In the decorative sheet obtained, a basis weight of an intermediate layer was 60 g/m², and a basis weight of a protective layer was 80 g/m². A basis weight of each layer was adjusted by varying the application amount.

### Comparative Example 5

A decorative sheet was prepared and evaluated as described in Example 6 except that an ultraviolet absorbing agent was not added. The results are shown in Table 1. In the decorative sheet obtained, a basis weight of an intermediate layer was 60 g/m², and a basis weight of an ultraviolet absorbing layer was 80 g/m². A basis weight of each layer was adjusted by varying the application amount.

TABLE 1

| | | | Example | | | | | | | |
|---|---|---|---|---|---|---|---|---|---|---|
| | | | 1 | 2 | 3 | 4 | 5 | 6 | 7 | 8 |
| Decolorized cork layer | | | Present | Present | Present | Present | Present | Present | Present | Present |
| Intermediate layer | | | Present | Present | Present | Present | Present | Present | Present | Present |
| Ultraviolet | Coating | Aqueous | 300 | 300 | 300 | 300 | 300 | | 300 | 300 |
| absorbing | agent | urethane agent | | | | | | | | |
| layer¹⁾ | (parts | Aqueous acrylic | | | | | | 300 | | |
| | by mass) | agent | | | | | | | | |
| | Ultraviolet | Benzophenone | 30 | 25 | 20 | 10 | 5 | 30 | | |
| | absorbing | compound | | | | | | | | |
| | agent | Benzotriazole | | | | | | | 30 | |
| | (parts by | compound | | | | | | | | |
| | weight) | Cyanoacrylate | | | | | | | | 30 |
| | | compound | | | | | | | | |

| | | | | | | | | |
|---|---|---|---|---|---|---|---|---|
| Content (parts by mass) of | 28.6 | 23.8 | 19 | 9.5 | 4.8 | 28.6 | 28.6 | 28.6 |
| an ultraviolet absorbing | | | | | | | | |
| agent based on 100 parts | | | | | | | | |
| by mass of a resin | | | | | | | | |

| | | | | | | | | |
|---|---|---|---|---|---|---|---|---|
| Light resistance | A | B | C | C | D | A | C | D |
| Fastness | A | A | A | A | A | B | A | A |

| | | | Comparative Example | | | | |
|---|---|---|---|---|---|---|---|
| | | | 1 | 2 | 3 | 4 | 5 |
| Decolorized cork layer | | | Absent | Present | Present | Present | Present |
| Intermediate layer | | | Absent | Absent | Present | Present | Present |
| Ultraviolet | Coating | Aqueous | | | | 300 | |
| absorbing | agent | urethane agent | | | | | |
| layer¹⁾ | (parts | Aqueous acrylic | | | | | 300 |
| | by mass) | agent | | | | | |
| | Ultraviolet | Benzophenone | | | | | |
| | absorbing | compound | | | | | |
| | agent | Benzotriazole | | | | | |
| | (parts by | compound | | | | | |
| | weight) | Cyanoacrylate | | | | | |
| | | compound | | | | | |

Content (parts by mass) of
an ultraviolet absorbing
agent based on 100 parts
by mass of a resin

| | | | | | |
|---|---|---|---|---|---|
| Light resistance | E | E | E | E | E |
| Fastness | C | C | C | A | B |

¹⁾In Examples 1 to 8, an ultraviolet absorbing layer was formed using an aqueous urethane emulsion (Examples 1 to 5, 7, 8) or an aqueous acrylic emulsion (Example 6) obtained by adding an ultraviolet absorbing agent to a commercially available coating agent. In Comparative Examples 4 and 5, the layer was formed using a commercially available coating agent alone.

The decorative sheets of Examples 1 to 8 in which the decolorized cork layer was formed on the surface of the cork sheet and the ultraviolet absorbing layer was formed as a protective layer on the surface of the intermediate layer were excellent in light resistance and fastness to rubbing, and maintained a unique appearance of cork even after ultraviolet irradiation and rubbing test. In particular, when a benzophenone compound was used as the ultraviolet absorbing agent (Examples 1 and 6), light resistance was significantly improved. Further, when the ultraviolet absorbing layer was formed using the aqueous urethane emulsion (Examples 1 to 5, 7, 8), fastness to rubbing was significantly improved. In contrast, light resistance and fastness to rubbing were low in the cork sheet in which the decolorized cork layer, the intermediate layer or the ultraviolet absorbing layer was not formed (Comparative Example 1), the cork sheet in which the intermediate layer or the ultraviolet absorbing layer was not formed (Comparative Example 2), and the cork sheet in which the ultraviolet absorbing layer was not formed (Comparative Example 3). Further, when a protective layer was formed using an aqueous urethane emulsion free from the ultraviolet absorbing agent (Comparative Examples 4 and 5), light resistance of the cork sheet obtained was insufficient.

### DESCRIPTIONS OF SYMBOLS

1: Decorative sheet
2: Cork sheet
3: Intermediate layer
4: Protective layer
5: Decolorized cork layer
6: Ultraviolet absorbing layer
7: Layer

1. A decorative sheet composed of a multilayer structure having an intermediate layer and a protective layer on a surface of a cork sheet, wherein
a decolorized cork layer is formed on the surface of the cork sheet in contact with the intermediate layer;
the intermediate layer is a coated film formed by drying an aqueous emulsion;
the protective layer comprises an ultraviolet absorbing layer made of a resin composition containing an ultraviolet absorbing agent; and
the surface of the protective layer is a design surface.

2. The decorative sheet according to claim 1, wherein the ultraviolet absorbing agent is a benzophenone compound containing a hydroxy group.

3. The decorative sheet according to claim 1, wherein
the ultraviolet absorbing agent is a benzophenone compound containing a hydroxy group, and
the ultraviolet absorbing layer is a coated film formed by drying an aqueous urethane emulsion comprising the ultraviolet absorbing agent.

4. The decorative sheet according to claim 1, wherein
the ultraviolet absorbing agent is a benzophenone compound containing a hydroxy group, and
the resin composition in the ultraviolet absorbing layer comprises 100 parts by mass of a resin and 5 to 60 parts by mass of the ultraviolet absorbing agent.

5. The decorative sheet according to claim 1, wherein
the ultraviolet absorbing agent is a benzophenone compound containing a hydroxy group;
the protective layer further comprises a layer made of a resin composition free from an ultraviolet absorbing agent; and
the layer made of the resin composition free from an ultraviolet absorbing agent is disposed outside the ultraviolet absorbing layer.

6. The decorative sheet according to claim 1, wherein
the ultraviolet absorbing agent is a benzophenone compound containing a hydroxy group, and
a basis weight (g/m²) of the protective layer is larger than a basis weight (g/m²) of the intermediate layer.

7. The decorative sheet according to claim 1, wherein
the ultraviolet absorbing agent is a benzophenone compound containing a hydroxy group, and
the intermediate layer is a coated film formed by drying an aqueous emulsion containing a colorant.

8. The decorative sheet according to claim 1, wherein the ultraviolet absorbing layer is a coated film formed by drying an aqueous urethane emulsion comprising the ultraviolet absorbing agent.

9. The decorative sheet according to claim 1, wherein
the ultraviolet absorbing layer is a coated film formed by drying an aqueous urethane emulsion comprising the ultraviolet absorbing agent, and
the resin composition in the ultraviolet absorbing layer comprises 100 parts by mass of a resin and 5 to 60 parts by mass of the ultraviolet absorbing agent.

10. The decorative sheet according to claim 1, wherein the resin composition in the ultraviolet absorbing layer comprises 100 parts by mass of a resin and 5 to 60 parts by mass of the ultraviolet absorbing agent.

11. The decorative sheet according to claim 1, wherein
the protective layer further comprises a layer made of a resin composition free from an ultraviolet absorbing agent; and
the layer made of the resin composition free from an ultraviolet absorbing agent is disposed outside the ultraviolet absorbing layer.

12. The decorative sheet according to claim 1, wherein a basis weight (g/m²) of the protective layer is larger than a basis weight (g/m²) of the intermediate layer.

13. The decorative sheet according to claim 1, wherein
a basis weight (g/m²) of the protective layer is larger than a basis weight (g/m²) of the intermediate layer, and
the intermediate layer is a coated film formed by drying an aqueous emulsion containing a colorant.

14. The decorative sheet according to claim 1, wherein the intermediate layer is a coated film formed by drying an aqueous emulsion containing a colorant.

15. A method for manufacturing a decorative sheet composed of a multilayer structure having an intermediate layer and a protective layer on a surface of a cork sheet, comprising
decolorizing the surface of the cork sheet to form a decolorized cork layer;
applying an aqueous emulsion on the decolorized cork layer and then drying the emulsion, to form the intermediate layer; and
applying an aqueous emulsion containing an ultraviolet absorbing agent on the intermediate layer and then drying the emulsion, to form the protective layer.
